(19) United States
(12) Patent Application Publication
(10) Pub. No.: US 2009/0282441 A1
(43) Pub. Date: Nov. 12, 2009

(54) Digital broadcasting filler device

(76) Inventor: Eliav Zipper, Ramat-Gan (IL)

Correspondence Address: EITAN MEHULAL LAW GROUP, 10 Abba Eban Blvd. PO Box 2081, Herzlia, 46120, IL

(21) Appl. No.: 12/149,970

(22) Filed: May 12, 2008

(51) Int. Cl. H04N 7/167

(52) U.S. Cl. 725/62

(57) ABSTRACT

A gap filler device for retransmitting at least a portion of an RF signal comprising RF circuitry adapted to receive the RF signal, and digital demodulation circuitry adapted to digitally filter at least a portion of the RF signal.

### FIELD

The disclosure relates to digital broadcasting.

### BACKGROUND

Digital television (DTV) was introduced in the 1990's, and generally refers to a type of communication system comprising transmitting and receiving television video and audio in digital format. DTV generally provides for substantially better video and sound quality compared to analog television. Additionally, as digital channels take up less bandwidth than analog channels, DTV can offer services and facilities not possible with analog television, such as, for example, greater number of channels, multimedia, user interactivity, and electronic program guide selection of spoken languages, selection of subtitle languages, and more.

DTV broadcasting is generally done through terrestrial networks, satellite networks, cable networks, and/or through the Internet. Traditionally, DTV broadcasting focused on reception by stationary devices, for example, an HDTV (high definition television) television set adapted for DTV reception and/or an analog television set with a set-top box (STB) adapted to convert the received DTV digital signals into analog video and audio signals.

Over the last few years, DTV broadcasting has also focused towards reception by mobile devices. These mobile devices, which are adapted to receive DTV transmissions while carried by a person or installed in a moving vehicle such as a car, a boat, and/or an aircraft, may include cellular phones, lap-top computers, personal digital assistants (PDAs), personal navigation equipment, portable media players, and the like. In some instances, the mobile devices may be further adapted to receive DTV broadcasts destined for stationary devices.

Standards for DTV broadcasting to mobile devices generally are relevant to wireless reception, and to mobile digital television (MDTV) broadcasting through terrestrial networks and satellite networks. These standards generally attempt to define and/or describe transmission methods which allow for substantially good reception by mobile devices. Factors typically considered are, for example, rapid movement of the mobile devices and/or low-power consumption in the mobile devices. An example of such an MDTV standard is Digital Video Broadcasting-Handheld (DVB-H), which comprises a technical specification for bringing broadcast services to mobile handsets. DVB-H was formally adopted as European Telecommunications Standard Institute (ETSI) standard EN 302 304 in November 2004, and is incorporated herein by reference. Additional standards and documents related to DVB-H, and incorporated herein by reference, may be found at www.dvb-h.org.

Transmission methods used by MDTV networks and by terrestrial DTV networks may vary within a same region, or from region to region, including from country to country and/or from continent to continent. For example, North American networks generally use ATSC (Advanced Television System Committee) for terrestrial DTV and FLO (Forward Link Only) for MDTV; European networks generally use DVB-T (Digital Video Broadcast-Terrestrial) for terrestrial DTV and DVB-H for MDTV; Japanese networks generally use ISDB-T (Integrated Services Digital Broadcasting-Terrestrial); Chinese networks generally use S-TiMi (Satellite and Terrestrial Interactive Multiservice Infrastructure). The variations in the transmission methods are generally related to the type of modulation used. For example, ATSC transmission methods are based on vestigial sideband (VSB) modulation while DVB-T is based on orthogonal frequency division multiplexing (OFDM). As a result, the DTV receivers in a network within a certain region generally are not adapted to receive DTV transmissions from another network with a different transmission method, whether in the same region or different region.

A problem occasionally encountered in television is “weak” reception. Weak reception may frequently be caused by interference in a path between a transmitter and a receiver, which may result in an attenuation of a signal's strength. When the attenuation is substantially large, the signal that reaches the receiver may be too weak for recognition by the receiver, (degradation in signal to noise ratio), and frequently a displayed picture will freeze, or loss of communication (reception) is experienced. This phenomenon may be especially relevant for reception within buildings where the buildings' walls may have a tendency to substantially degrade the signal's strength. Other examples of signal strength degradation as a result of interferences are: in cities, where tall buildings between the transmitter and receiver degrades the signal's strength; in open areas, where mountains degrade the signal's strength; and within cars, where the car's exterior degrades the signal's strength. Possible solutions to the problem of weak reception include increasing transmitting power of the transmitters and/or increasing the number of transmitters within a certain area (increase density of transmitters).

Another possible solution is based on the use of a device generally known as a gap filler device. Gap filler devices are typically used to amplify and retransmit RF signals so as to enable an otherwise weak signal to reach receivers in areas of poor reception capabilities. Small gap filler devices (SGF) generally comprise small to medium power repeaters adapted to receive the weak signal through a receiving antenna, filter and amplify the signal, and retransmit it by means of a transmitting antenna to one or more receivers located within a same house, and/or a same building. DVB-H319, “DVB-H Small Gap Fillers Task Force—Technical Requirements & Regulation Issues” dated 4 Jul. 2006, the document which is incorporated herein by reference, discloses “a minimum set of requirements that any domestic or in-car low power gap filler device should meet.”

Reference is made to FIG. 1, which schematically illustrates a black-box representation of an SGF 100, based on DVB-H 349r6 “Digital Video Broadcasting (DVB); Technical Specifications for DVB-H Small Gap Filler”, the document incorporated herein by reference. SGF 100 comprises two black boxes, a signal processing box 101 and a signal quality monitoring box 102. SGF 100 additionally comprises a receiving antenna 103 adapted to receive an incoming RF (radio frequency) signal (RF IN) from an MDTV broadcast source (not shown), which may comprise, for example, one or more satellite and/or terrestrial networks; and further comprises a transmitting antenna 104, adapted to transmit an outgoing RF signal (RF OUT) from SGF 100 to one or more MDTV receiving devices. Signal processing box 101 typically comprises RF circuitry and is adapted to produce RF OUT by filtering and amplifying RF IN. Signal quality monitoring box 102 typically comprises demodulation circuitry and is adapted to perform signal quality monitoring, including, for example, channel selection, RF IN quality measurement, RF OUT quality measurement, and Quality of Service (QoS) indication. It is also used to control the gain of signal processing black box 101.

Reference is made to FIG. 2, which schematically illustrates an exemplary circuit diagram of the RF circuitry comprised in signal processing box 101 of FIG. 1, according to a prototype based on DVB-H320 “Small Gap Filler Task Force—Conclusions of Study Mission”, the document incorporated herein by reference. Reference is also made to FIG. 1. SGF 100 comprises a dual conversion heterodyne transceiver-like architecture, and includes three SAW (surface acoustic wave) filters, high IF (RF) SAW 114, low IF SAW 118, and high IF (RF) SAW 124; an optional band-pass filter 110; a harmonic filter 128; and two synthesizers (local oscillators), LO 130 and LO 131.

In signal processing box 101, RF IN is input to optional band-pass filter (BPF) 110 adapted to filter frequencies in RF IN below 470 MHz and above 862 MHz. A filtered signal output from BPF 110 is input to an RF amplifier 112, the RF amplifier adapted to amplify the filtered signal. An amplified signal is output from RF amplifier 112 and is fed into a mixer 113, the mixer adapted to perform frequency conversion of the amplified signal, for example, by multiplying it by a LO signal ranging in frequency from 1694-2078 MHZ produced by variable frequency oscillator (LO) 130.

A mixed signal is output by mixer 113 and is fed into RF SAW filter 114, the filter adapted to filter substantially all frequencies above and below 1220 MHz. A filtered signal from RF SAW 114 is fed into a mixer 115, the mixer adapted to perform frequency conversion of the filtered signal, for example, by multiplying it by a signal of frequency 1184 MHZ produced by local oscillator (LO) 131. A mixed signal is output by mixer 115 and is fed into intermediate frequency IF SAW filter 118, the filter adapted to filter substantially all signals above and below 36 MHz.

An output IF signal from IF SAW filter 118 is fed into a mixer 122, the mixer adapted to perform frequency conversion of the filtered signal, for example, by multiplying it by the signal of frequency 1184 MHZ produced by LO 131. A mixed signal is output by mixer 122 and is fed into RF SAW filter 124, the filter adapted to filter substantially all frequencies above and below 1220 MHz. A filtered signal from RF SAW 124 is fed into a mixer 125, the mixer adapted to perform frequency conversion of the filtered signal, for example, by multiplying it by a signal ranging in frequency from 1694-2078 MHZ produced by LO 130. A mixed signal is output by mixer 125 and is fed into an RF power amplifier 126, the RF power amplifier adapted to amplify the power of the mixed signal to levels suitable for transmission to the MDTV devices. A power signal output by RF amplifier 126 is fed into a low pass harmonic filter (LPF) 128, the BPF adapted to filter substantially all frequencies in the signal above 862 MHz and below 470 MHz. A filtered signal, RF OUT, of substantially the same frequency as RF IN, is output from BPF 128, and is fed into antenna 104 for transmission to the MDTV devices.

### SUMMARY

An aspect of some embodiments of the invention relates to providing a device, such as a small gap filler (SGF), which comprises a zero-intermediate frequency topology (ZIF), and which substantially eliminates a use of SAW filters, and/or a plurality of oscillators. The SGF is adapted to receive an RF IN, filter the signal in the analog and digital domain, and amplify the filtered signal to produce an RF OUT, which may be transmitted to MDTV devices. Optionally, RF OUT may be transmitted to mobile devices adapted to receive digital multimedia broadcasting (DMB). The outgoing signal RF OUT is a stronger signal of substantially the same frequency as the incoming signal RF IN. The SGF is further adapted to provide signal quality monitoring.

According to an aspect of some embodiments of the invention, RF IN is demodulated into base-band I and Q components, using zero-intermediate frequency ZIF demodulation in an analog domain. The base-band I and Q components are then decoded and filtered in a digital domain with a digital low pass filter, and subsequently encoded and re-modulated in the analog domain. The resulting signal is amplified and filtered to produce RF OUT.

In an embodiment of the invention, the SGF comprises RF circuitry and digital demodulation circuitry. The RF circuitry is adapted to produce RF OUT by filtering and amplifying RF IN. The digital demodulation circuitry is adapted to perform signal quality monitoring, including, for example, channel selection, RF IN quality measurement, RF OUT quality measurement, and Quality of Service (QoS) indication. A part of the demodulation circuitry may be further adapted to perform the digital low pass filtering of the decoded base-band I and Q components in the RF circuitry.

The RF circuitry comprises an RF low noise amplifier (LNA) adapted to amplify a weak RF IN while introducing substantially minimal noise into the circuit; an IQ down-converter adapted to perform quadrature down-conversions of the amplified RF IN into base-band I and Q components; an analog low pass filter for the I and Q components, the filter adapted to filter out undesired channel frequencies; an analog-to-digital converter (ADC) adapted to decode the filtered I and Q components into I and Q bit streams; a digital low pass filter adapted to perform channel filtering of the bit streams based on signal quality monitoring; a digital-to-analog converter (DAC) adapted to encode the digitally filtered bit stream into I and Q components in the analog domain; a low pass filter adapted to filter out undesired out-of-band signals and recover the base-band I and Q components; an IQ modulator adapted to perform quadrature up-conversions of the base-band I and Q components to produce a modulated signal at a carrier frequency (carrier signal); a power amplifier adapted to amplify the power of the carrier signal suitable for transmission to the MDTV devices; and a harmonic filter adapted to reduce harmonic levels. Additionally there may be comprised in the RF circuit a synthesizer adapted to produce a signal at frequencies required to extract the carrier frequency during the quadrature down-conversion, and add the carrier frequency during the quadrature up-conversions. The synthesizer may comprise a local oscillator such as, for example, an analog oscillator and/or a digital oscillator.

The demodulation circuitry comprises digital circuitry adapted to perform the signal quality monitoring, and further adapted to perform digital low pass filtering of the I and Q bit streams. Included in the demodulation circuitry may be a controller and/or a digital signal processor (DSP). Optionally, the ADC and/or the DAC, or parts thereof, are comprised in the controller.

In some embodiments of the invention, the SGF may comprise an envelope detector to control output power, IQ mismatch, and carrier leakage. Optionally, a DC (direct current) cancellation mechanism may be at a base-band section between the IQ down-converter and the IQ up-converter (modulator). Additionally or alternatively, a programmable gain amplifier (PGA) may be included in the I and Q paths for ADC dynamic range utilization and IQ gain mismatch cancellation. Optionally, an input pre-selector RF filter is added to reduce out-of-band interference. Optionally, a DC offset may be added clipping the input to the DAC, thereby enabling local oscillator leakage calibration of the IQ modulator. Optionally, coding may be adapted to the DAC. Additionally or alternatively, a post IQ modulator RF PGA may be added to have optional means of controlling output power.

The inventors have found that the disclosed embodiments in which SAW filters and a plurality of oscillators are not used, allow for a lower cost and smaller dimension SGF. Additional savings in cost and dimensions may be achieved by using in the RF circuit, functions which generally are intrinsic to the digital demodulation circuitry, such as for example, the digital low pass filter or the ADC or the DAC.

There is provided, in accordance with an embodiment of the invention, a gap filler device for retransmitting at least a portion of an RF signal, the gap filler comprising RF circuitry adapted to receive the RF signal and digital demodulation circuitry adapted to digitally filter at least a portion of the RF signal. Optionally, the device is a small gap filler (SGF). Additionally, the device may further comprise a receiving antenna and a transmitting antenna.

In some embodiments of the invention, the RF signal is a mobile digital television (MDTV) broadcast signal. Optionally, the RF signal is a digital multimedia broadcast (DMB) signal. Optionally, the RF signal is an Advanced Television System Committee (ATSC) signal. Additionally or alternatively, the RF signal is a Forward Link Only (FLO) signal. Optionally, the RF signal is a Digital Video Broadcast-Terrestrial (DVB-T) signal. Optionally, the RF signal is a Digital Video Broadcast-Handheld (DVB-H) signal. Optionally, the RF signal is an Integrated Services Digital Broadcasting-Terrestrial (ISDB-T) signal. Optionally, the RF signal is Satellite and Terrestrial Interactive Multiservice Infrastructure (S-TiMi) signal.

In some embodiments of the invention, the RF circuitry is further adapted to demodulate the RF signal into base-band I and Q components. Optionally, demodulation comprises zero intermediate frequency (ZIF) demodulation. Additionally, the demodulation circuitry may be further adapted to decode the RF signal into I and Q bit streams. Optionally, the demodulation circuitry is further adapted to perform channel selection in the RF signal. Optionally, the demodulation circuitry is further adapted to measure the quality of the RF signal.

There is provided, in accordance with an embodiment of the invention, a circuit for retransmitting a digital television broadcast (DTV) signal to a mobile device, the circuit comprising at least one digital low pass filter adapted to digitally filter the DTV broadcast signal. Additionally, the circuit may further comprise a local oscillator adapted to produce a signal at a carrier frequency; at least one analog-to-digital converter (ADC) adapted to decode the DTV broadcast signal into quadrature I and Q bit streams in a digital domain; at least one digital-to-analog converter (DAC) adapted to convert digitally filtered I and Q bit streams into I and Q components in an analog domain; and an RF low noise amplifier adapted to amplify the DTV broadcast signal. Optionally, the circuit further comprises a quadrature IQ down-converter adapted to demodulate the DTV broadcast signal into base-band I and Q components. Additionally, the circuit may further comprise an analog low pass filter adapted to filter out undesired channel frequencies in the DTV broadcast signal; an analog low pass filter adapted to filter out undesired out-of-band signals and recover base-band I and Q components in the DTV broadcast signal; a quadrature IQ up-converter adapted to modulate the base-band I and Q components into a carrier frequency of the DTV broadcast signal; and a power amplifier adapted to increase the strength of the DTV broadcast signal.

There is provided, in accordance with an embodiment of the invention, a circuit for retransmitting a digital multimedia broadcast (DMB) signal to a mobile device, the circuit comprising at least one digital low pass filter adapted to digitally filter the DMB broadcast signal. Additionally, the circuit may further comprise a local oscillator adapted to produce a signal at a carrier frequency; at least one analog-to-digital converter (ADC) adapted to decode the DTV broadcast signal into quadrature I and Q bit streams in a digital domain; at least one digital-to-analog converter (DAC) adapted to convert digitally filtered I and Q bit streams into I and Q components in an analog domain; an RF low noise amplifier adapted to amplify the DMB broadcast signal. Optionally, the circuit further comprises a quadrature IQ down-converter adapted to demodulate the DMB broadcast signal into base-band I and Q components. Additionally, the circuit may further comprise an analog low pass filter adapted to filter out undesired channel frequencies in the DMB broadcast signal; an analog low pass filter adapted to filter out undesired out-of-band signals and recover base-band I and Q components in the DTV broadcast signal; a quadrature IQ up-converter adapted to modulate the base-band I and Q components into a carrier frequency of the DMB broadcast signal; and a power amplifier adapted to increase the strength of the DMB broadcast signal.

There is provided, in accordance with an embodiment of the invention, a circuit for retransmitting a DVB-H signal to a mobile device, the circuit comprising at least one digital low pass filter adapted to digitally filter the DVB-H broadcast signal. Additionally, the circuit may further comprise a local oscillator adapted to produce a signal at a carrier frequency; at least one analog-to-digital converter (ADC) adapted to decode the DVB-H broadcast signal into quadrature I and Q bit streams in a digital domain; at least one digital-to-analog converter (DAC) adapted to convert digitally filtered I and Q bit streams into I and Q components in an analog domain; and an RF low noise amplifier adapted to amplify the DVB-H broadcast signal. Optionally, the circuit further comprises a quadrature IQ down-converter adapted to demodulate the DVB-H broadcast signal into base-band I and Q components. Additionally, the circuit may further comprise an analog low pass filter adapted to filter out undesired channel frequencies in the DVB-H broadcast signal; an analog low pass filter adapted to filter out undesired out-of-band signals and recover base-band I and Q components in the DTV broadcast signal; a quadrature IQ up-converter adapted to modulate the base-band I and Q components into a carrier frequency of the DVB-H broadcast signal; and a power amplifier adapted to increase the strength of the DVB-H broadcast signal.

There is provided, in accordance with an embodiment of the invention, a circuit for retransmitting a DVB-T signal to a mobile device, the circuit comprising at least one digital low pass filter adapted to digitally filter the DVB-T broadcast signal. Additionally, the circuit may further comprise a local oscillator adapted to produce a signal at a carrier frequency; at least one analog-to-digital converter (ADC) adapted to decode the DVB-T broadcast signal into quadrature I and Q bit streams in a digital domain; at least one digital-to-analog converter (DAC) adapted to convert digitally filtered I and Q bit streams into I and Q components in an analog domain; and an RF low noise amplifier adapted to amplify the DVB-T broadcast signal. Optionally, the circuit further comprises a quadrature IQ down-converter adapted to demodulate the DVB-T broadcast signal into base-band I and Q components. Additionally, the circuit may further comprise an analog low pass filter adapted to filter out undesired channel frequencies in the DVB-T broadcast signal; an analog low pass filter adapted to filter out undesired out-of-band signals and recover base-band I and Q components in the DTV broadcast signal; a quadrature IQ up-converter adapted to modulate the base-band I and Q components into a carrier frequency of the DVB-T broadcast signal; and a power amplifier adapted to increase the strength of the DVB-T broadcast signal.

There is provided, in accordance with an embodiment of the invention, a circuit for retransmitting an ATSC signal to a mobile device, the circuit comprising at least one digital low pass filter adapted to digitally filter the ATSC broadcast signal. Additionally, the circuit may further comprise a local oscillator adapted to produce a signal at a carrier frequency; at least one analog-to-digital converter (ADC) adapted to decode the ATSC broadcast signal into quadrature I and Q bit streams in a digital domain; at least one digital-to-analog converter (DAC) adapted to convert digitally filtered I and Q bit streams into I and Q components in an analog domain; and an RF low noise amplifier adapted to amplify the ATSC broadcast signal. Optionally, the circuit further comprises a quadrature IQ down-converter adapted to demodulate the ATSC broadcast signal into base-band I and Q components. Additionally, the circuit may further comprise an analog low pass filter adapted to filter out undesired channel frequencies in the ATSC broadcast signal; an analog low pass filter adapted to filter out undesired out-of-band signals and recover base-band I and Q components in the DTV broadcast signal; a quadrature IQ up-converter adapted to modulate the base-band I and Q components into a carrier frequency of the ATSC broadcast signal; and a power amplifier adapted to increase the strength of the ATSC broadcast signal.

There is provided, in accordance with an embodiment of the invention, a circuit for retransmitting an FLO signal to a mobile device, the circuit comprising at least one digital low pass filter adapted to digitally filter the FLO broadcast signal. Additionally, the circuit may further comprise a local oscillator adapted to produce a signal at a carrier frequency; at least one analog-to-digital converter (ADC) adapted to decode the FLO broadcast signal into quadrature I and Q bit streams in a digital domain; at least one digital-to-analog converter (DAC) adapted to convert digitally filtered I and Q bit streams into I and Q components in an analog domain; and an RF low noise amplifier adapted to amplify the FLO broadcast signal. Optionally, the circuit further comprises a quadrature IQ down-converter adapted to demodulate the FLO broadcast signal into base-band I and Q components. Additionally, the circuit may further comprise an analog low pass filter adapted to filter out undesired channel frequencies in the FLO broadcast signal; an analog low pass filter adapted to filter out undesired out-of-band signals and recover base-band I and Q components in the DTV broadcast signal; a quadrature IQ up-converter adapted to modulate the base-band I and Q components into a carrier frequency of the FLO broadcast signal; and a power amplifier adapted to increase the strength of the FLO broadcast signal.

There is provided, in accordance with an embodiment of the invention, a circuit for retransmitting an ISDB-T signal to a mobile device, the circuit comprising at least one digital low pass filter adapted to digitally filter the ISDB-T broadcast signal. Additionally, the circuit may further comprise a local oscillator adapted to produce a signal at a carrier frequency; at least one analog-to-digital converter (ADC) adapted to decode the ISDB-T broadcast signal into quadrature I and Q bit streams in a digital domain; at least one digital-to-analog converter (DAC) adapted to convert digitally filtered I and Q bit streams into I and Q components in an analog domain; and an RF low noise amplifier adapted to amplify the ISDB-T broadcast signal. Optionally, the circuit further comprises a quadrature IQ down-converter adapted to demodulate the ISDB-T broadcast signal into base-band I and Q components. Additionally, the circuit may further comprise an analog low pass filter adapted to filter out undesired channel frequencies in the ISDB-T broadcast signal; an analog low pass filter adapted to filter out undesired out-of-band signals and recover base-band I and Q components in the DTV broadcast signal; a quadrature IQ up-converter adapted to modulate the base-band I and Q components into a carrier frequency of the ISDB-T broadcast signal; and a power amplifier adapted to increase the strength of the ISDB-T broadcast signal.

There is provided, in accordance with an embodiment of the invention, a circuit for retransmitting an S-TIMI signal to a mobile device, the circuit comprising at least one digital low pass filter adapted to digitally filter the S-TIMI broadcast signal. Additionally, the circuit may further comprise a local oscillator adapted to produce a signal at a carrier frequency; at least one analog-to-digital converter (ADC) adapted to decode the S-TIMI broadcast signal into quadrature I and Q bit streams in a digital domain; at least one digital-to-analog converter (DAC) adapted to convert digitally filtered I and Q bit streams into I and Q components in an analog domain; and an RF low noise amplifier adapted to amplify the S-TIMI broadcast signal. Optionally, the circuit further comprises a quadrature IQ down-converter adapted to demodulate the S-TIMI broadcast signal into base-band I and Q components. Additionally, the circuit may further comprise an analog low pass filter adapted to filter out undesired channel frequencies in the S-TIMI broadcast signal; an analog low pass filter adapted to filter out undesired out-of-band signals and recover base-band I and Q components in the DTV broadcast signal; a quadrature IQ up-converter adapted to modulate the base-band I and Q components into a carrier frequency of the S-TIMI broadcast signal; and a power amplifier adapted to increase the strength of the S-TIMI broadcast signal.

There is provided, in accordance with an embodiment of the invention, a method for retransmitting at least a portion of an RF signal using a gap filler device comprising receiving the RF signal, and digitally filtering at least a portion of the RF signal. Optionally, the device is a small gap filler (SGF). Additionally, the method may further comprise receiving the RF signal using a receiving antenna, and transmitting the RF signal using a transmitting antenna.

In some embodiments of the invention, the RF signal is a mobile digital television (MDTV) broadcast signal. Optionally, the RF signal is a digital multimedia broadcast (DMB) signal.

In some embodiments of the invention, the method further comprises demodulating the RF signal into base-band I and Q components. Optionally, the RF signal is demodulated using zero intermediate frequency (ZIF) demodulation.

In some embodiments of the invention, the method further comprises decoding the RF signal into I and Q bit streams. Additionally, the method may further comprise performing channel selection in the RF signal. Optionally, the method further comprises measuring the quality of the RF signal.

### BRIEF DESCRIPTION OF FIGURES

Examples illustrative of embodiments of the invention are described below with reference to figures attached hereto. In the figures, identical structures, elements or parts that appear in more than one figure are generally labeled with a same numeral in all the figures in which they appear. Dimensions of components and features shown in the figures are generally chosen for convenience and clarity of presentation and are not necessarily shown to scale. The figures are listed below.

FIG. 1 schematically illustrates a black-box representation of an SGF, based on DVB-H 349r6;

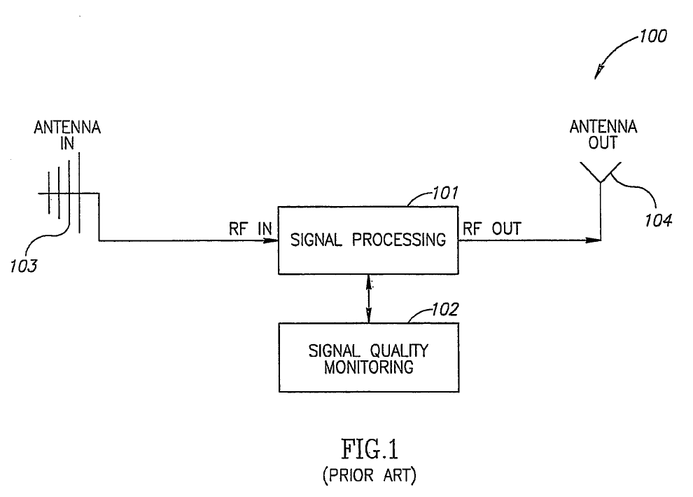

FIG. 2 schematically illustrates an exemplary circuit diagram of an RF circuitry comprised in a signal processing box shown in FIG. 1, according to a prototype described in DVB-H 320;

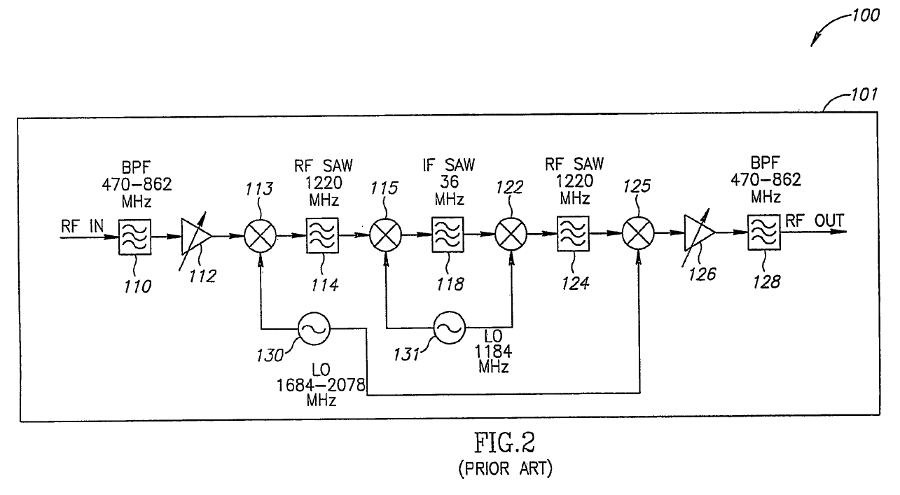

FIG. 3 schematically illustrates a black-box representation of an SGF, in accordance with an embodiment of the invention;

FIG. 4 schematically illustrates an exemplary circuit diagram of an RF circuit and a Demodulation circuit comprised in the SGF shown in FIG. 3, in accordance with an embodiment of the invention; and

FIG. 5 schematically illustrates a flow diagram of the operation of the SGF shown in FIGS. 3 and 4, in accordance with an embodiment of the invention.

### DETAILED DESCRIPTION

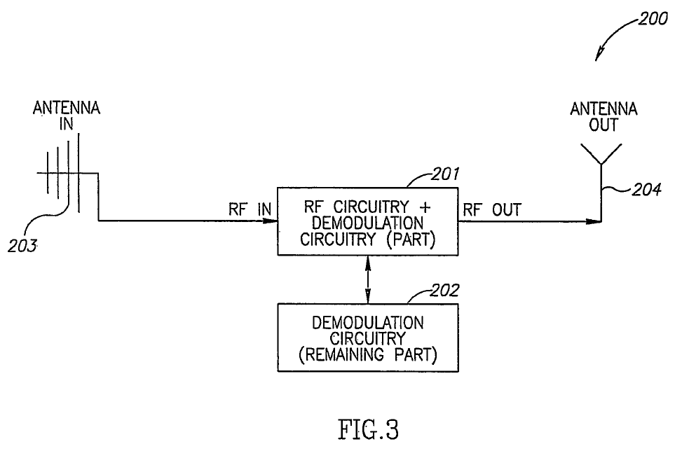

Reference is made to FIG. 3, which schematically illustrates a black-box representation of an SGF 200, in accordance with an embodiment of the invention. SGF 200 comprises two black boxes, RF circuitry and part of digital demodulation circuitry 201 and a remaining part of digital demodulation circuitry 202. For convenience hereinafter, the two black boxes may be referred to as RF circuit 201 and Demodulation circuit 202. SGF 200 additionally comprises a receiving antenna 203 adapted to receive an incoming RF signal, RF IN, from an MDTV broadcast source (not shown), which may comprise for example one or more satellite and/or terrestrial networks; and further comprises a transmitting antenna 204, adapted to transmit an outgoing RF signal, RF OUT, from SGF 200 to one or more MDTV receiving devices. Optionally, SGF 200 may be adapted to receive an RF IN from a DMB source and to transmit an RF OUT to mobile devices adapted to receive DMB.

RF circuit 201 comprises RF circuitry and part of digital demodulation circuitry, and is adapted to produce RF OUT by filtering and amplifying RF IN. Furthermore, RF circuit 201 is adapted to demodulate RF IN into base-band I and Q components, using ZIF demodulation in an analog domain, decode and filter the base-band I and Q components in a digital domain with a digital low pass filter (DLPF), encode and re-modulate recovered base-band I and Q components to a carrier frequency (carrier signal), and amplify and harmonically filter the carrier signal to produce RF OUT. Demodulation circuit 202 comprises a remaining portion of digital demodulation circuitry comprised in RF circuit 201, and is adapted to perform signal quality monitoring, including, for example, channel selection, RF IN quality measurement, RF OUT quality measurement, and Quality of Service (QoS) indication.

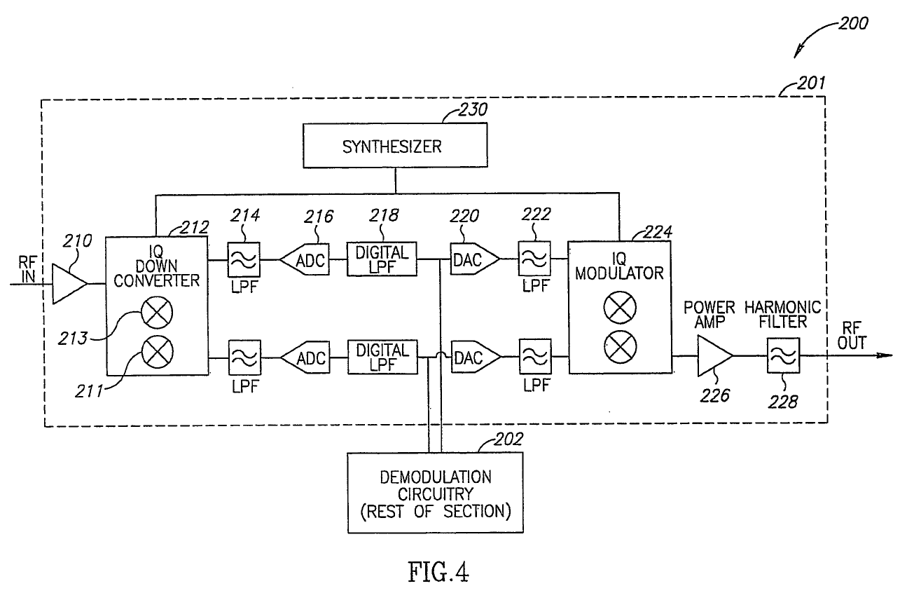

Reference is made to FIG. 4, which schematically illustrates an exemplary circuit diagram of RF circuit 201 and of Demodulation circuit 202, comprised in SGF 200, and shown in FIG. 3, in accordance with an embodiment of the invention. Reference is also made to FIG. 3.

In RF circuit 201, RF IN is received from receiving antenna 203 and is input to an RF LNA 210, RF LNA 210 adapted to amplify a weak RF IN and further adapted to introduce substantially minimal noise into the circuit. The amplified RF IN is input to IQ down-converter 212, down converter 212 adapted to perform quadrature down-conversion of the amplified RF IN into base-band I and Q components. Down-conversion into the base-band I and Q components may be performed by feeding a carrier frequency signal produced by synthesizer 230 into mixer 211 and an orthogonally phase shifted equivalent into mixer 212, and low pass filtering the mixed signal obtained from each mixer to eliminate the carrier frequency. The base-band I and Q components may be obtained from mixer 211 and 213, respectively, or alternatively, from mixer 213 and 211, respectively. Synthesizer 230 may comprise a local oscillator such as an analog oscillator and/or a digital oscillator.

The base-band I and Q components are each input into a low pass filter (LPF) 214, LPF 214 adapted to filter out undesired channel frequencies. An output of low pass filter 214 is fed into ADC 216 where the I and Q components are converted (decoded) into I and Q bit streams. The I and Q bit streams are then channel filtered by a DLPF 218. In accordance with an embodiment of the invention DLPF 218 may be comprised in a controller, or optionally a DSP, included in the demodulation circuitry adapted to perform signal quality monitoring. Channel filtering of the I and Q bit streams is performed in response to feedback received from the demodulation circuitry regarding signal quality. Optionally, ADC 216 may be comprised in the controller. An output of DLPF 218 is fed into DAC 220, DAC 220 adapted to encode the digitally filtered bit streams into I and Q components in the analog domain. The I and Q components are fed into an LPF 222, the filter adapted to filter out undesired out-of-band signals and recover the base-band I and Q components. The output of LPF 222 is fed into IQ modulator 224, modulator 224 adapted to perform quadrature up-conversions of the base-band I and Q components to a carrier frequency by mixing the base-band I and Q components with the carrier frequency signal of synthesizer 230. A modulated signal at carrier frequency (carrier signal) is output from IQ modulator 224 and is fed into a power amplifier 226, power amplifier 226 adapted to increase the power of the carrier signal. The carrier signal is then fed into a harmonic filter 228, harmonic filter 228 adapted to reduce harmonic level. The output of harmonic filter 228 is RF OUT, which is input to transmitting antenna 204 for transmission to the MDTV devices, or optionally DMB mobile devices.

In some embodiments of the invention, SGF 200 may comprise an envelope detector to control output power, IQ mismatch, and carrier leakage. Optionally, a DC (direct current) cancellation mechanism may be added to a base-band section between IQ down-converter 211 and IQ up-converter (modulator) 224. Additionally or alternatively, a programmable gain amplifier (PGA) may be included in the I and Q paths for ADC dynamic range utilization and IQ gain mismatch cancellation. Optionally, an input pre-selector RF filter is added to reduce out-of-band interference. Optionally, a DC offset may be added, clipping the input to DAC 220, thereby enabling synthesizer 230 leakage calibration of IQ modulator 224. Optionally, coding may be adapted to DAC 220. Additionally or alternatively, a post IQ modulator RF PGA may be added to have optional means of controlling output power.

Demodulation circuit 202 comprises those components in the digital demodulation circuitry which are not used in RF circuit 201 and are used for signal quality monitoring. Some examples of the components not comprised in Demodulation circuit 202 may include DLFP 218 and/or ADC 216.

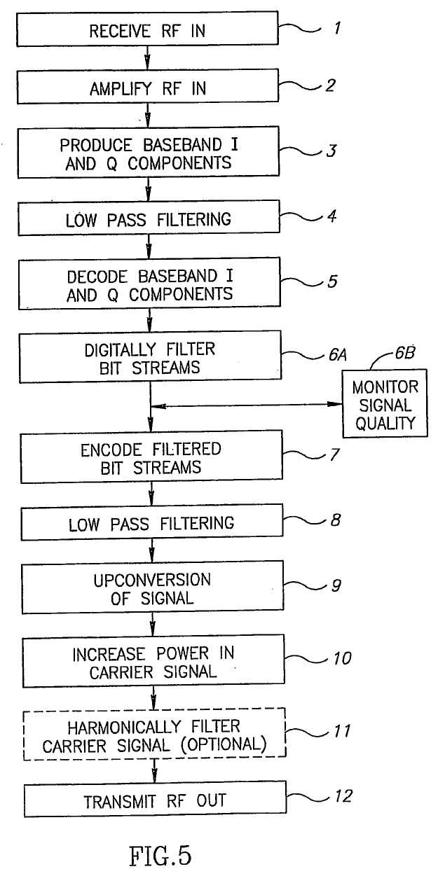

Reference is made to FIG. 5, which schematically illustrates a flow diagram of an exemplary mode of operation (method) of SGF 200 shown in FIGS. 3 and 4, in accordance with an embodiment of the invention. It may be appreciated by a person skilled in the art that the method described herein may be applied in other sequences for the described embodiments, and may be applied in the same sequence described, or in other sequences, to other embodiments of the invention.
[STEP 1] An incoming RF signal RF IN is received by receiving antenna 203. RF signal may be a signal transmitted from an MDTV broadcasting source, or optionally, a DMB source.
[STEP 2] RF IN is input to RF LNA 210 where the signal is amplified and noise is substantially maintained to a minimum.
[STEP 3] An amplified RF IN is down-converted into base-band I and Q components in IQ down-converter 212 by combining with a carrier frequency signal produced by synthesizer 230, and low pass filtering of the mixed signal.
[STEP 4] The base-band I and Q components are input to low pass filter 214 to remove undesired channel frequencies.
[STEP 5] The filtered base-band I and Q components are input to ADC 216 to produce an I and Q bit stream.
[STEPS 6A & 6B] The I and Q bit streams are filtered by digital low pass filter 218. Filtering is performed responsive to feedback provided by the digital demodulation circuitry which, is continuously monitoring signal quality.
[STEP 7] The output of digital low pass filter 218 is fed into DAC 220 for encoding into base-band I and Q components in the analog domain.
[STEP 8] The base-band I and Q components are input to low pass filter 222 to remove undesired out-of-band signals and recover the base-band I and Q components.
[STEP 9] The recovered base-band I and Q components are up-converted to a carrier signal by modulating the base-band I and Q components with the carrier frequency signal from synthesizer 230.
[STEP 10] The carrier signal is input to power amplifier 226 to increase power of signal for transmission purposes.
[STEP 11] The relatively high power carrier signal is optionally input to harmonic filter 228 to reduce harmonic level. The harmonically filtered carrier signal is RF OUT.
[STEP 12] RF OUT is transmitted from transmitting antenna 204 to MDTV devices. Optionally, RF OUT is transmitted to DBM mobile devices.

In the description and claims of embodiments of the present invention, each of the words, “comprise” “include” and “have”, and forms thereof, are not necessarily limited to members in a list with which the words may be associated.

The invention has been described using various detailed descriptions of embodiments thereof that are provided by way of example and are not intended to limit the scope of the invention. The described embodiments may comprise different features, not all of which are required in all embodiments of the invention. Some embodiments of the invention utilize only some of the features or possible combinations of the features. Variations of embodiments of the invention that are described and embodiments of the invention comprising different combinations of features noted in the described embodiments will occur to persons with skill in the art.

1. A gap filler device for retransmitting at least a portion of an RF signal comprising:
RF circuitry adapted to receive the RF signal; and
digital demodulation circuitry adapted to digitally filter at least a portion of said RF signal.

2. The device of claim 1 wherein the device is a small gap filler (SGF).

3. The device of claim 1 wherein the RF signal is a mobile digital television (MDTV) broadcast signal.

4. The device of claim 1 wherein the RF signal is a digital multimedia broadcast (DMB) signal.

5. The device of claim 1 wherein the RF signal is an Advanced Television System Committee (ATSC) signal.

6. The device of claim 1 wherein the RF signal is a Forward Link Only (FLO) signal.

7. The device of claim 1 wherein the RF signal is a Digital Video Broadcast-Terrestrial (DVB-T) signal.

8. The device of claim 1 wherein the RF signal is a Digital Video Broadcast-Handheld (DVB-H) signal.

9. The device of claim 1 wherein the RF signal is an Integrated Services Digital Broadcasting-Terrestrial (ISDB-T) signal.

10. The device of claim 1 wherein the RF signal is Satellite and Terrestrial Interactive Multiservice Infrastructure (S-TiMi) signal.

11. The device of claim 1 wherein said RF circuitry is further adapted to demodulate the RF signal into base-band I and Q components.

12. The device of claim 1 wherein demodulation comprises zero intermediate frequency (ZIF) demodulation.

13. The device of claim 1 wherein said demodulation circuitry is further adapted to decode the RF signal into I and Q bit streams.

14. The device of claim 1 wherein said demodulation circuitry is further adapted to perform channel selection in the RF signal.

15. The device of claim 1 wherein said demodulation circuitry is further adapted to measure the quality of the RF signal.

16. A circuit for retransmitting a digital television broadcast (DTV) signal to a mobile device, the circuit comprising:
at least one digital low pass filter adapted to digitally filter the DTV broadcast signal.

17. The circuit of claim 16, further comprising at least one analog-to-digital converter (ADC) adapted to decode the DTV broadcast signal into quadrature I and Q bit streams in a digital domain.

18. The circuit of claim 16, further comprising at least one digital-to-analog converter (DAC) adapted to convert digitally filtered I and Q bit streams into I and Q components in an analog domain.

19. The circuit of claim 16 further comprising a quadrature IQ down-converter adapted to demodulate the DTV broadcast signal into base-band I and Q components.

20. The circuit of claim 16 further comprising an analog low pass filter adapted to filter out undesired out-of-band signals and recover base-band I and Q components in the DTV broadcast signal.

21. The circuit of claim 16 further comprising a quadrature IQ up-converter adapted to modulate the base-band I and Q components into a carrier frequency of the DTV broadcast signal.

22. A method for retransmitting at least a portion of an RF signal using a gap filler device comprising:
receiving said RF signal; and
digitally filtering at least a portion of said RF signal.

23. The method of claim 22 wherein the device is a small gap filler (SGF).

24. The method of claim 22 wherein the RF signal is a mobile digital television (MDTV) broadcast signal.

25. The method of claim 22 wherein the RF signal is a digital multimedia broadcast (DMB) signal.

26. The method of claim 22 further comprising demodulating the RF signal into base-band I and Q components.

27. The method of claim 22 wherein RF signal is demodulated using zero intermediate frequency (ZIF) demodulation.

28. The method of claim 22 further comprising decoding the RF signal into I and Q bit streams.

29. The method of claim 22 further comprising performing channel selection in the RF signal.

30. The method of claim 22 further comprising measuring the quality of the RF signal.
